(19) United States
(12) Patent Application Publication
(10) Pub. No.: US 2006/0111851 A1
(43) Pub. Date: May 25, 2006

(54) Fuel theft detection system and method

(75) Inventors: Johannes Hermanus Potgieter, Randburg (ZA); Patrick Desmond Fourie, Alberton (ZA)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: JOHANNES HERMANUS POTGIETER, RANDBURG (ZA)

(21) Appl. No.: 10/521,223

(22) PCT Filed: Jul. 16, 2003
(86) PCT No.: PCT/IB03/02815

§ 371 Date: Sep. 7, 2005

(30) Foreign Application Priority Data
Jul. 16, 2002 (ZA) 2002/5663

(51) Int. Cl. G01F 23/00; G01F 17/00

(52) U.S. Cl. 702/35

(57) ABSTRACT

A fuel theft detection system (50) for detecting when fuel has been stolen from a vehicle's fuel tank (16) is disclosed. The detection system (50) comprises input means (56) that is connectable to a vehicle's fuel level sensor (14) for providing an indication of the fuel level in the vehicle's fuel tank (16). A controller (22) is connected to the input means (56) for controlling the system (50), with the system (50) further including timing means (72) for driving the controller (22) to capture and record the fuel level at regular, pre-determined intervals. The controller (22) is arranged to calculate and store the average fuel level over successive periods of time, with any deviation in the fuel level by more than a predetermined amount suggesting fuel theft. Significantly, the controller (22) is simultaneously able to determine fuel theft when fuel is being dispensed into the fuel tank (16).

### BACKGROUND OF THE INVENTION

THIS invention relates to a fuel theft detection system and method.

The theft of fuel is a rampant problem that costs the transport industry vast amounts of money. There are several methods in which fuel is stolen, including 1) fuel being siphoned from a vehicle's fuel tank, 2) the owner of a vehicle or a fleet of vehicles being overcharged for the actual quantity of fuel that has been dispensed to the vehicle(s), or 3) where a single fuel payment card is used to dispense fuel to a number of different vehicles.

Typically, the second and third ways described above of stealing fuel take place where the driver of the vehicle and/or the fleet manager are/is in collusion with the workers and/or owners of filling stations. The second method, namely overcharging, is particularly common as fuel gauges are generally not very accurate in terms of confirming a vehicle operator's claim that he or she filled the vehicle's fuel tank completely. Thus, the vehicle's owner will pay for a full tank of fuel, say, 60 litres, whereas in fact only 50 litres was pumped into the vehicle. The owner is none the wiser because generally fuel gauges are not sufficiently accurate to indicate that the fuel tank is only, for example, 90% full, and not 100% full as claimed. In addition, it is impractical for the owner to check each and every vehicle that has just been filled with fuel.

There are several systems presently available that seek to address the problem of fuel theft. The most accurate of these systems involves measuring the actual amount of fuel that has been combusted by the vehicle's engine. Thus, for example, in a diesel powered vehicle this involves measuring the flow of fuel before it enters the injector pump and the flow of excess fuel back to the tank. Whilst this system is relatively accurate, it is generally prohibitively expensive, and, it is believed, can be manipulated if the flow of fuel is intercepted and redirected between the device and the injector pump.

A second system of preventing fuel theft takes the form of a sleeve that is simply inserted into the neck of the fuel tank, which serves to prevent the insertion of a siphon, thereby preventing the siphoning of fuel directly out of the fuel tank. The primary problem with such a system is that fuel can still be removed from the fuel tank via, for example, the drain plug of the fuel tank, by removing the fuel level meter cap, or from the fuel line directly.

Other systems that are aimed at preventing fuel theft involve fitting an electronic vehicle identification unit around the neck of the fuel tank. The nozzle of the fuel pump is in turn also fitted with an electronic device, with the two devices being programmed so that the fuel pump will only dispense fuel if the vehicle identification unit on the vehicle's fuel tank is actively identified. The resulting transaction is then recorded, and is thus relatively foolproof. There are however certain limitations with this system, with the primary one being that fuel can still be siphoned from the fuel tank. In addition, this system only works at filling stations where such technology exists.

It would therefore be desirable to provide a fuel theft detection system and method that addresses the abovementioned problems.

### SUMMARY OF THE INVENTION

According to a first aspect of the invention there is provided a fuel theft detection system for detecting when fuel has been stolen from a vehicle's fuel tank, the detection system comprising:
input means that is connectable to a vehicle's fuel level sensor for providing an indication of the fuel level in the vehicle's fuel tank;
a controller connected to the input means;
timing means for driving the controller to capture and record the fuel level at regular, pre-determined intervals; and
storage means for storing the recorded data,

wherein the controller is arranged to calculate the average fuel level over a first period of time, and to then store the resulting average fuel level in the storage means for later analysis, so that any deviation in the fuel level in successive periods of time by more than a predetermined amount would suggest fuel theft, with the controller, after the fuel tank has been filled with fuel, also being arranged to determine the amount of fuel that has been dispensed into the fuel tank and to then enable a comparison to be made between the amount of fuel actually dispensed into the fuel tank and the amount of fuel alleged to have been dispensed into the fuel tank, with any discrepancy between these two values also suggesting fuel theft.

Preferably, the system includes a reference value defining means for defining a plurality of intermediate reference values between a truly full fuel tank and a truly empty fuel tank.

Conveniently, the storage means includes reference value profiles for all existing fuel level sensors and fuel tanks, with the relevant reference value profile being selected when the system is installed into the vehicle.

Typically, the input means produces an analogue signal indicative of the fuel level, with the system further including an analogue to digital converter for converting the analogue signal into a digital signal, the resulting digital signal defining a primary input for the system.

Advantageously, the timing means is an oscillator, with the regular, pre-determined interval being approximately 10 seconds.

Conveniently, the system is connected in series between a vehicle's ignition switch and the vehicle's fuel level sensor in the fuel tank.

Preferably, the storage means is fitted with a transmitter for transmitting the stored, recorded data to a remote receiver.

According to a second aspect of the invention there is provided a fuel theft detection method for detecting when fuel has been stolen from a vehicle's fuel tank, the method comprising the steps of:
sensing the fuel level in the vehicle's fuel tank;
capturing and recording the fuel level at regular, pre-determined intervals;
storing the recorded data;
calculating the average fuel level over a first period of time;
storing the resulting average fuel level in the storage means for later analysis, so that any deviation in the fuel level in successive periods of time by more than a predetermined amount would suggest fuel theft; and
after the fuel tank has been filled with fuel, determining the amount of fuel that has been dispensed into the fuel tank, so that a comparison can be made between the amount of fuel actually dispensed into the fuel tank and the amount of fuel alleged to have been dispensed into the fuel tank, with any discrepancy between these two values also suggesting fuel theft.

Preferably, the method includes the step of defining a plurality of intermediate reference values between a truly full fuel tank and a truly empty fuel tank.

Conveniently, the method further includes the steps of:
providing reference value profiles for all existing fuel level sensors and fuel tanks; and
selecting the relevant reference value profile.

### BRIEF DESCRIPTION OF THE DRAWINGS

FIG. 1 shows a schematic block diagram of a fuel theft detection system according to a first embodiment of the present invention;

FIG. 2 shows a schematic diagram of how the system shown in FIG. 1 can be connected to a communications network that would allow transmission of information obtained by the fuel detection system to a base station;

FIG. 3 shows an example of a record that would be produced by the system shown in FIG. 1 for assisting in the detection of fuel theft; and

FIG. 4 shows a schematic block diagram of a fuel theft detection system according to a second, preferred embodiment of the present invention.

### DESCRIPTION OF EMBODIMENTS

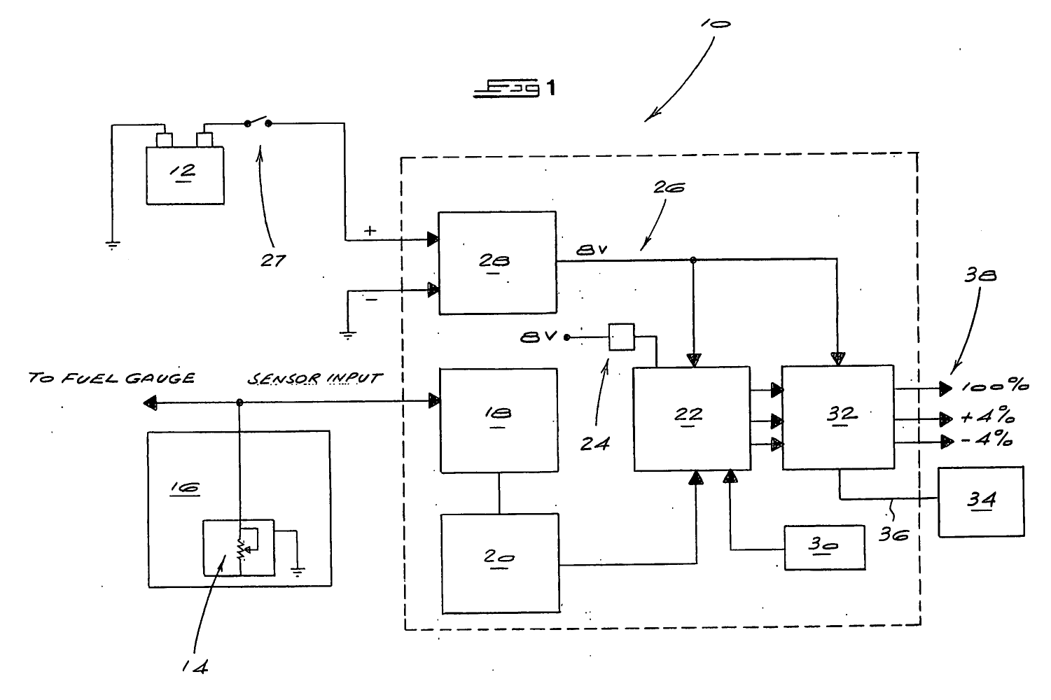

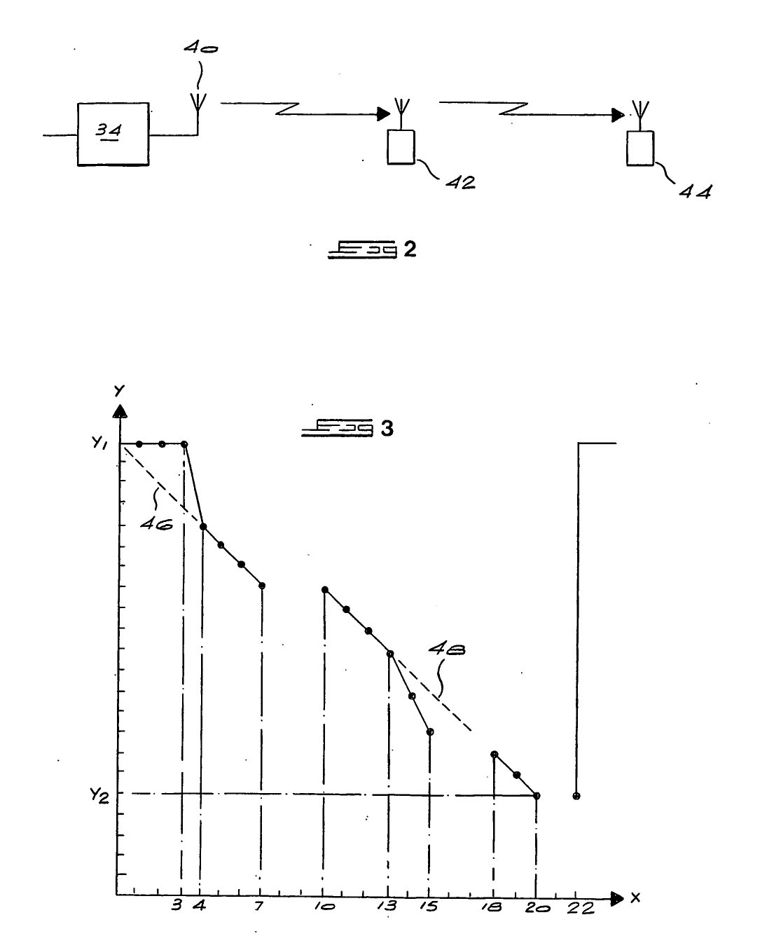

Referring to FIGS. 1 and 2, a fuel theft detection system 10 is shown connected in series between a vehicle's battery 12 and a vehicle's fuel level sensor 14 in a fuel tank 16. The fuel level sensor 14 is in turn connected to the vehicle's fuel gauge and drives the fuel gauge so as to provide a visual indication to the driver or operator of the vehicle of the amount of fuel in the fuel tank 16 at any particular moment. Significantly, the fuel level sensor 14 thus provides a sensor input, in the form of a voltage level indicative of the fuel level in the tank 16, to the system 10.

The system 10 includes a filter and delay circuit 18 for filtering the incoming voltage, and an analogue to digital converter 20 for converting the incoming analogue voltage signal into a digital signal. The resulting digital signal defines a primary input for a peripheral interface controller 22.

Additional inputs for the controller 22 include a calibration module 24 for allowing the system 10, and in particular the controller 22, to be provided with upper, intermediate and lower reference voltages corresponding to a truly full fuel tank, intermediate fuel levels in the tank and to a truly empty fuel tank. The calibration module 24 typically takes the form of a plurality of DIP switches. These reference values vary according to the fuel level sensor 14 being used in fuel tank 16, and will typically be measured and stored in the controller 22 during the installation of the system 10 into a vehicle.

Alternatively, these reference voltages for a variety of fuel level sensors could be pre-programmed into the controller 22, so that upon installation of the system 10 into the vehicle, the appropriate fuel level sensor type can be selected and stored in the controller 22 from the calibration module 24. The significance of these upper, intermediate and lower reference voltages will be described in more detail further on in the specification.

A power supply rail 26 powers the controller 22 via ignition switch 27. In particular, the system 10 is powered by the vehicle's battery 12 via a power supply module 28. The module 28 includes a filter to eliminate voltage fluctuations that would occur, for example, when the vehicle's indicators are being operated, as well as a regulator for regulating the DC voltage to the controller 22 at 5 V.

A further input into the controller is an oscillator 30, which serves to drive the controller 22 so that every 10 seconds the voltage of the fuel level sensor 14 is captured and transmitted to an output buffer 32. The buffer 32 serves to temporarily hold the data that is transmitted between the controller 22 and a peripheral storage device 34 via serial data output line 36.

The peripheral storage device 34 will typically take the form of an existing recording device within the vehicle, such as an on board computer, satellite tracking device or a fleet management system, for example. If the vehicle is not provided with such a recording device, a dedicated recording device or any of the storage devices mentioned above would need to be fitted to the vehicle in order to record the serial data.

Typically, the data that is sent to, and stored in, the peripheral storage 34 device is first encoded by the controller 22. The output buffer 32 has a number of additional digital outputs 38 that could, for example, be used to provide the status of the system 10 to the driver or operator of the vehicle by means of an on-board console.

In use, the fuel level sensor 14 is continuously monitoring the fuel level in the fuel tank 16, with the controller 22 ultimately receiving a digital signal corresponding to the fuel level. Approximately every 10 seconds, the voltage transmitted by the sensor 14 is recorded and stored in the output buffer 32. After one minute, the average voltage of the 6 voltage readings that have been stored in the buffer 32 for that particular minute, referred to as the minute average, is calculated by the controller 22 and also stored in the output buffer 32. After 5 minutes, an average of the 5 one minute averages, referred to as a cycle average, is calculated by the controller 22 and transmitted to, and stored in, the peripheral storage device 34.

The purpose of obtaining average values is to compensate for fluctuations in the fuel level as a result of, for example, the vehicle being positioned on an incline, turning a corner, stopping or accelerating etc. Clearly, the figures provided above, namely 10 seconds, every minute, and after 5 minutes, are all examples and are merely provided to assist in explaining the operation of the present invention.

In this embodiment, the peripheral storage device 34 is fitted with a transmitter 40 that will transmit the data stored in the device 34 to a first receiver 42. The first receiver 42 will typically be situated at the grounds where the vehicle is kept when not in use. It is envisaged that the data could then be transmitted to a second receiver 44, situated at a base station, where a third party would store and analyse the received data and notify the vehicle owner when it has been suspected that fuel has been stolen.

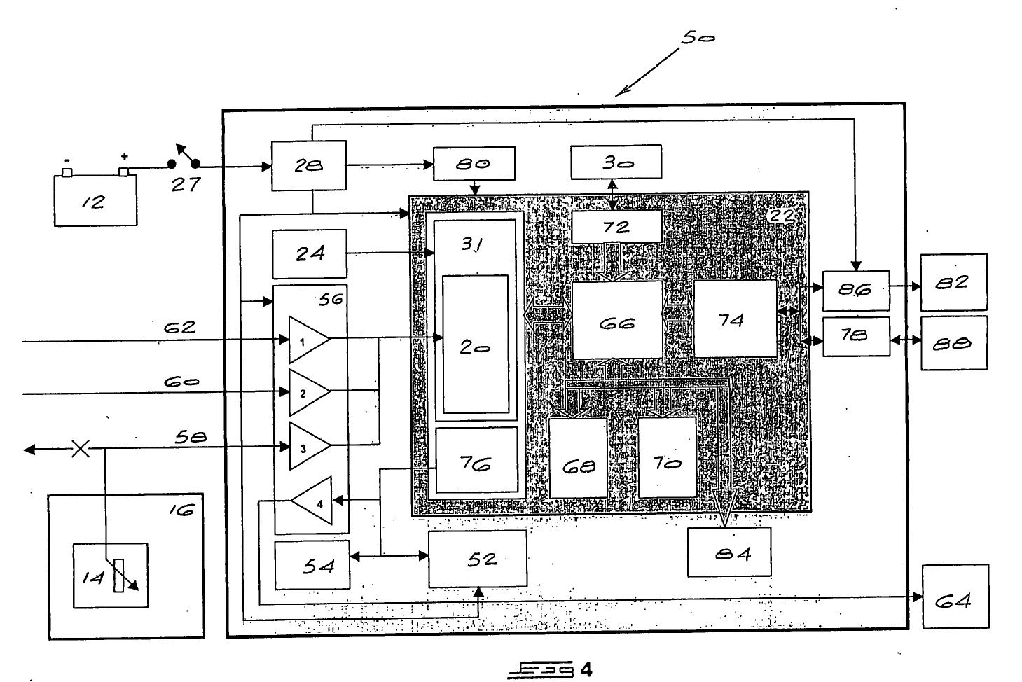

The data stored in the storage device 34 can be plotted and thus analysed. An example of such a graph is shown in FIG. 3, with the x-axis corresponding to time and being set out in 5 minute intervals, and the y-axis corresponding to the level of fuel in the tank. The gradient of this graph would thus give an indication of the fuel consumption of the vehicle.

The graph is flat over the first 3 time intervals because it normally takes a while for fuel gauge sensors to sense a drop in the fuel level. However, fuel theft could still be detected during this period by extending the point at which the first fuel level drop is detected, which in this case occurs at interval no. 4, back towards the first value that was detected, as indicated by broken line 46. If the gradient of this line 46 is approximately equal to the gradient of the lines during normal vehicle usage, such as between intervals 4 and 7, 10 and 13 and 18 and 20, then it could be concluded that no fuel theft took place during this period.

The breaks in the graph between intervals 7 and 10, 15 and 18, and 20 and 22 indicate that the vehicle was switched off during these intervals. It would be expected for the fuel level to stay the same before and after the vehicle has been switched off, and is true for the breaks in the graph between intervals 7 and 10, and between 20 and 22. However, the fuel level drops between intervals 15 and 18, which suggests that fuel was stolen whilst the vehicle was off during this period.

If fuel is stolen whilst the vehicle is running, the graph would follow the curve indicated between intervals 13 and 15. This deviates significantly from line 48, which is what the graph between these two points would resemble had there not been fuel theft. Thus, by monitoring the fuel level for each 5 minute cycle, any deviation in the fuel level by, for example, 4% in a given cycle will suggest a discrepant rate of fuel consumption, and thus the possibility of fuel theft.

Lastly, at interval 22, it can be seen that the tank was filled with fuel. Assuming that the tank is fully filled, the value y₁ on the graph corresponds to the upper reference voltage described above. The value y₂ would be close to the lower reference voltage, or to one of the intermediate values, described above to allow the quantity of fuel that has been pumped into the fuel tank to be relatively accurately calculated. This can then be compared to the quantity of fuel billed. Any discrepancy will indicate that the owner of the vehicle has been charged for fuel that was in fact never put into the fuel tank 16. Thereafter, the owner will know which operator or driver to monitor, with the owner then being in a position to take appropriate action based on the data obtained by the system 10 of the present invention.

The controller 22, as mentioned above, is calibrated to indicate a tank 16 that is truly full, thereby eliminating the possibility of a vehicle operator claiming to have fully filled the tank 16 but in fact not having done so. A brief review of the data recorded by the storage device 34 will quickly reveal to what extent the vehicle was filled with fuel within a specific period of time. Thus, if the system 10 is calibrated, for example, that 4 V (i.e. the reference voltage) corresponds to a full tank, and after the operator claims to have fully filled the tank 16, the voltage is only 3 V, there is a strong suggestion that fuel has been stolen. The extent of such theft measured in litres, the date and time such theft took place and, if connected to a satellite tracking device, where such theft took place, can therefore be determined.

Turning now to FIG. 4, elements that are identical to the elements described above with reference to FIG. 1 are indicated with identical reference numerals. A fuel theft detection system 50 is shown connected in series between a vehicle's battery 12 and a vehicle's fuel level sensor 14 in a fuel tank 16. In this version, the fuel level sensor 14 is disconnected from the vehicle's existing fuel gauge and drives a digital fuel gauge 52 which is part of system 50 so as to provide a visual indication to the driver or operator of the vehicle of the amount of fuel in the fuel tank 16 at any particular moment.

The digital fuel gauge 52 is able to display the number of litres and/or the percentage of fuel remaining in the fuel tank 16 and includes a low fuel alarm 54. Significantly, the fuel level sensor 14 thus provides a sensor input, in the form of a voltage indicative of the fuel level in the tank 16, to the system 50.

The system 50 includes a input/output buffer circuit 56 for filtering the incoming/outgoing voltages. The input buffer filters the incoming voltage in respect of the fuel sensor input 58, rpm source input 60 and electronic distance input 62. The rpm source input 60 and electronic distance input 62 will only be connected if the owner of a vehicle wishes to calculate fuel cost per kilometer and/or fuel cost per hour. The output buffer filters the outgoing voltage in respect of an analogue output 64.

The system 50 furthermore includes a controller 22 which consists of an input port which contains inter alia an analogue to digital converter 20, a central processing unit (CPU) 66, program memory 68, data memory 70, timing generator 72, communication ports 74 and output ports 76.

Any incoming analogue voltage signal input is, in the first instance, converted by the analogue to digital converter 20 into a digital signal. The resulting digital signal defines a primary input for the controller 22.

Additional inputs for the controller 22 include a calibration module 24 for allowing the system 50, and in particular the controller 22, to be able to select the data applicable to the tank and sensor type of the vehicle. As indicated above, the calibration module 24 typically takes the form of a plurality of DIP switches. These values vary according to the fuel level sensor 14 being used in fuel tank 16, and can be measured and stored in the controller 22 during the installation of the system 50 into a vehicle. Such values can also be downloaded via communication port 78.

Preferably, these reference voltages for a variety of fuel level sensors are pre-programmed into the data memory 70, and controlled by the program memory 68 of the controller 22, so that upon installation of the system 50 into the vehicle, the appropriate fuel level sensor type can be selected from the calibration module 24. The significance of these upper, intermediate and lower reference voltages has been described above, and will thus not be described in more detail.

A power supply module 28 powers the controller 22 via the vehicle's battery 12, ignition switch 27 and back-up battery 80. The module 28 includes a filter to eliminate voltage fluctuations that would occur, for example, when the vehicle's indicators are being operated, as well as a regulator for regulating the DC voltage to the controller 22 at 5V.

A further input into the controller is an oscillator 30, which serves to drive the timing generator 72 of the controller 22 so that every 10 seconds the voltage of the fuel level sensor 14 is captured, converted by the analogue to digital converter 20 and transmitted to the CPU 66. The data memory 70 serves to temporarily hold the data that is transmitted between the fuel sensor 14 and the controller 22.

It is important to appreciate that the primary input into the CPU 66 is a reference voltage, corresponding to the fuel level in the fuel tank 16, which typically has a non-linear curve. From a truly full fuel tank to a truly empty fuel tank, this non-linear curve is linearised, so that every value on the non-linear curve has a corresponding value on the linear curve. These corresponding values typically taking the form of percentages, and define the reference values referred to in the attached claims. These reference, linear values also correspond to the values shown in the graph illustrated in FIG. 3, and serve to provide a more accurate indication of the fuel level in the tank.

This information is stored in data memory 70, with typically only 21 reference values being taken and stored. These 21 reference values correspond to 5% increments ranging from a truly empty fuel tank to a truly full fuel tank. The values between these 21 values are calculated by the CPU 66, by interpolation, and also stored in the data memory 70.

A peripheral storage device 82 will typically take the form of an existing recording device within the vehicle, such as an on board computer, satellite tracking device or a fleet management system, for example. If the vehicle is not provided with such a recording device, the recorded data can be stored on the external memory 84 for later transmission or any of the storage devices mentioned above would need to be fitted to the vehicle in order to record the serial data. The external memory 84 expands the capacity of the data memory 24 and will be utilised when data is to be kept for longer periods of time and downloaded less frequently.

Typically, the data is sent via communication ports 74 to a digital interface 86 or communication port 78 and stored in the peripheral storage device 82 or directly to the external memory 84. Alternatively, if such peripheral storage device 82 is incapable to receive a digital signal, an analogue signal 64 is provided via an output port 76 and output buffer 56(4).

In use, system 50 works the same as system 10 described above, with the fuel level sensor 14 continuously monitoring the fuel level in the fuel tank 16, so that the controller 22 receives a digital signal corresponding to the fuel level.

Approximately every 10 seconds, the voltage transmitted by the sensor 14 is recorded and stored in digital format in data memory 70, after it has been processed to determine the corresponding value on the linear curve, as described above. After one minute, the average of the 6 readings that have been stored for that particular minute, referred to as the minute average, is calculated by the CPU 66, displayed on the digital fuel gauge 52, and also stored. After 5 minutes, an average of the 5 one minute averages, referred to as a cycle average, is calculated by the CPU 66 and transmitted to, and stored in the external memory 84 or the peripheral storage device 82.

In one version of the invention, the external memory 84 or peripheral storage device 82 can be fitted with a transmitter that will transmit the data stored in the device 84 or 82 to a first receiver. The transmitter and first receiver mentioned here typically correspond to the transmitter 40 and first receiver 42 shown in FIG. 2. As described above, the first receiver will typically be situated at the grounds where the vehicle is kept when not in use. It is envisaged that the data could then be transmitted to a second receiver, situated at a base station, where a third party would store and analyse the received data and notify the vehicle owner when it has been suspected that fuel has been stolen. Data can also be transmitted via a physical down loader 88 or cell phone network for example.

The data stored in the external memory 84 or the storage device 82 can be plotted and thus analysed. An example of such a graph is shown in FIG. 3, which has already been described and explained above. As described above, a brief review of the data recorded by the external memory 84 or storage device 82 will quickly reveal to what extent the vehicle was filled with fuel within a specific period of time. Thus, if the system 50 is calibrated, for example, that 4 V (i.e. the reference voltage) corresponds to a full tank, and after the operator claims to have fully filled the tank 16, the voltage is only 3 V, there is a strong suggestion that fuel has been stolen. The extent of such theft measured in litres, the date and time such theft took place and, if connected to a satellite tracking device, where such theft took place, can therefore be determined.

The fuel theft detection system and method of the present invention has a number of advantages. The primary advantage is that it is able simultaneously to detect direct fuel theft, in other words, theft described in fuel theft method no. 1 in the background section of this specification, as well as fraudulent fuel theft, as described in fuel theft methods nos. 2 and 3. In particular, the direct fuel theft is detected by monitoring fuel levels in successive periods of time, whereas the fraudulent fuel theft is detected by comparing the amount of fuel actually dispensed into the fuel tank and the amount of fuel alleged to have been dispensed into the fuel tank. By simultaneously being able to determine both types of fuel theft, it is believed that the present invention will go a long way to addressing fuel theft.

1. A fuel theft detection system for detecting when fuel has been stolen from a vehicle's fuel tank, the detection system comprising:
input means that is connectable to a vehicle's fuel level sensor for providing an indication of the fuel level in the vehicle's fuel tank;
a controller connected to the input means;
timing means for driving the controller to capture and record the fuel level at regular, pre determined intervals;
storage means for storing the recorded data; and
wherein the controller is arranged to calculate the average fuel level over a first period of time, and to then store the resulting average fuel level in the storage means for later analysis, so that any deviation in the fuel level in successive periods of time by more than a predetermined amount would suggest fuel theft, with the controller, after the fuel tank has been filled with fuel, also being arranged to determine the amount of fuel that has been dispensed into the fuel tank and to then enable a comparison to be made between the amount of fuel actually dispensed into the fuel tank and the amount of fuel alleged to have been dispensed into the fuel tank, with any discrepancy between these two values also suggesting fuel theft.

2. A fuel theft detection system according to claim 1, which further includes a reference value defining means for defining a plurality of intermediate reference values between a truly full fuel tank and a truly empty fuel tank.

3. A fuel theft detection system according to either claim 1 or claim 2, wherein the storage means includes reference value profiles for all existing fuel level sensors and fuel tanks, with the relevant reference value profile being selected when the system is installed into the vehicle.

4. A fuel theft detection system according to claim 1, wherein the input means produces an analogue signal indicative of the fuel level, with the system further including an analogue to digital converter for converting the analogue signal into a digital signal, the resulting digital signal defining a primary input for the system.

5. A fuel theft detection system according to claim 1, wherein the timing means is an oscillator, with the regular, pre determined interval being approximately 10 seconds.

6. A fuel theft detection system according to claim 1, wherein the system is connected in series between a vehicle's ignition switch and the vehicle's fuel level sensor in the fuel tank.

7. A fuel theft detection system according to claim 1, wherein the storage means is fitted with a transmitter for transmitting the stored, recorded data to a remote receiver.

8. A fuel theft detection method for detecting when fuel has been stolen from a vehicle's fuel tank, the method comprising the steps of:
sensing the fuel level in the vehicle's fuel tank;
capturing and recording the fuel level at regular, pre determined intervals;
storing the recorded data;
calculating the average fuel level over a first period of time;
storing the resulting average fuel level for later analysis, so that any deviation in the fuel level in successive periods of time by more than a predetermined amount would suggest fuel theft; and
after the fuel tank has been filled with fuel, determining the amount of fuel that has been dispensed into the fuel tank, so that a comparison can be made between the amount of fuel actually dispensed into the fuel tank and the amount of fuel alleged to have been dispensed into the fuel tank, with any discrepancy between these two values also suggesting fuel theft.

9. A fuel theft detection method according to claim 8, which includes the step of defining a plurality of intermediate reference values between a truly full fuel tank and a truly empty fuel tank.

10. A fuel theft detection method according to either claim 8 or claim 9, which further includes the steps of:
providing reference value profiles for all existing fuel level sensors and fuel tanks; and
selecting the relevant reference value profile.

11. A fuel theft detection method according to claim 8, which includes the step of transmitting the stored, recorded data to a remote receiver.
